(19) United States
(12) Patent Application Publication
(10) Pub. No.: US 2005/0105285 A1
(43) Pub. Date: May 19, 2005

(54) Mouth-operated control device for a lighting system fixed on a helmet

(76) Inventor: Bernard Maden, Peronnas (FR)

Correspondence Address: Fay Sharpe Fagan Minnich & McKee, 1100 Superior Avenue, Seventh Floor, Cleveland, OH, 28383, US

(21) Appl. No.: 10/497,610

(22) PCT Filed: Nov. 27, 2002
(86) PCT No.: PCT/FR02/04074

(30) Foreign Application Priority Data
Dec. 1, 2001 (FR) 01/5644

(51) Int. Cl. F21V 21/084; F21V 23/04

(52) U.S. Cl. 362/105; 362/394

(57) ABSTRACT

A control device for a visible light and/or infrared lighting system (1) is designed to be fixed on one of the lateral walls of a helmet (4) via a retaining arm (2). The control device is actuated by the movement(s) of a user's mouth operating without using his hands on an optical or capacitive sensor (9) to pick up said movement(s).

### P BACKGROUND OF THE INVENTION

The present invention concerns a light device with a light control system. It more particularly relates to a light system for visible or infrared light.

The invention is more particularly designed for protective helmets, for example, astronautical helmets worn by pilots or mechanics of helicopters or airplanes, either military or civilian.

Such a light system permits, for example, team members of a night flight, with or without night vision goggles, to illuminate:
The interior environment of the cockpit to see the instruments or to read a map or other document
The exterior environment, with visible or infrared light, to detect obstacles or the displacement of the ground.

These systems are generally controlled manually, but given the concentration and the number of important operations which effect pilots such control constitutes a supplemental burden for them.

The aim of this invention is precisely that, to unburden the pilots, at least of their hands.

### SUMMARY OF THE INVENTION

To this end, it concerns a control device for a lighting system of either visible or infrared light, designed to be fixed on one of the lateral walls of the helmet by the intermediary of a retaining arm, characterized in that it is activated by the movement(s) of the mouth of the user, acting independently of their hands on optical or capacitive sensors adapted to capture the movement(s).

According to the complementary characteristics, the control device is laid out at the end of a solitary retaining arm of the helmet, in an articulated manner.

According to another characteristic, the aforementioned control device forms together with a lighting system an ensemble contained in a case which advantageously comprehends, two parts with one extremity constituting a lighted case and the other constituting a control case containing notably the movement sensor. In addition, according to the described mode of execution, the aforementioned case includes a programmable microcontroller and an electronic circuit all of which run electrically.

Let us add that the device comprehends a control case including a main switch and an electronic circuit for the current source.

According to other characteristics, the movement sensor allows by the intermediary of an electronic circuit to be implemented:
The control for the lighting or extinction of visible light electroluminescent diodes
The control for the lighting or extinction of infrared electroluminescent diodes
The control for the lighting intensity.

Let us specify that the effective command, take for example, introducing a tongue between the teeth and the lower lip which creates an embossing which is detected by the movement sensor, positioned at an adequate distance from the mouth of the user, take for example, along side the lower lip by the shaft of the control. Also the following functions:

If all the electroluminescent diodes are extinguished:
A rapid extension of 0.2 to 0.4 seconds illuminates the lighting diodes
Two rapid extensions illuminate the infrared diode

If the diodes are illuminated:
A rapid extensions extinguishes the lighted diodes
A longer extension, for example, of 0.7 seconds, launches the stepping of the electronic dimmer.

Still further advantages of the present invention will be appreciated to those of ordinary skill in the art upon reading and understand the following detailed description.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 is a perspective view of the helmet equipped with the first embodiment of the lighting system and its control device according to the invention.

FIG. 2 is a schematic view representing the electronic concept of the control system in FIG. 1.

FIG. 3 is a partial perspective view from the front of the device according to FIG. 2.

FIG. 4 is a partial perspective view from behind the device according to FIG. 1.

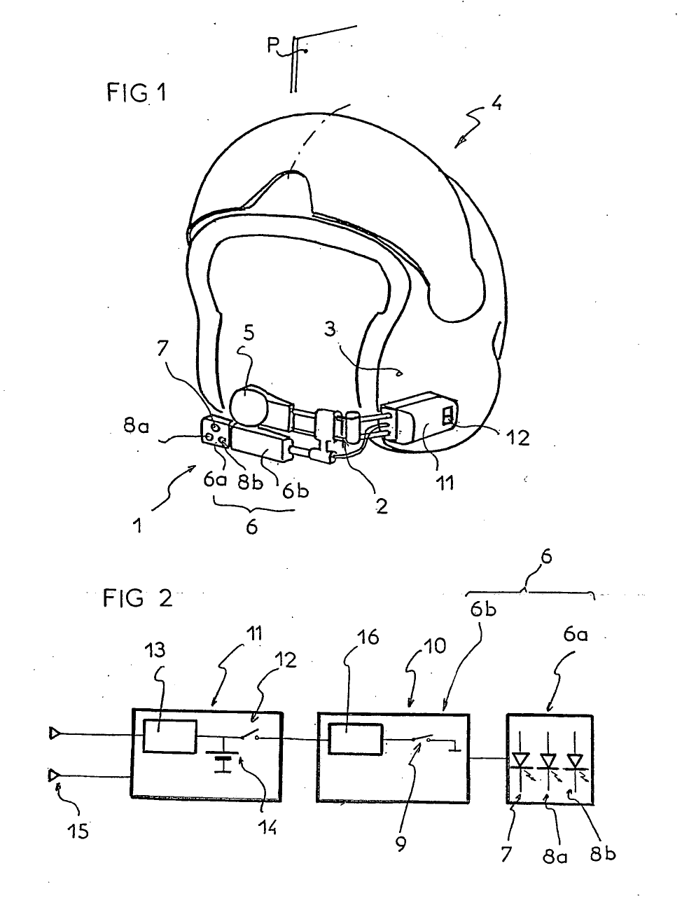

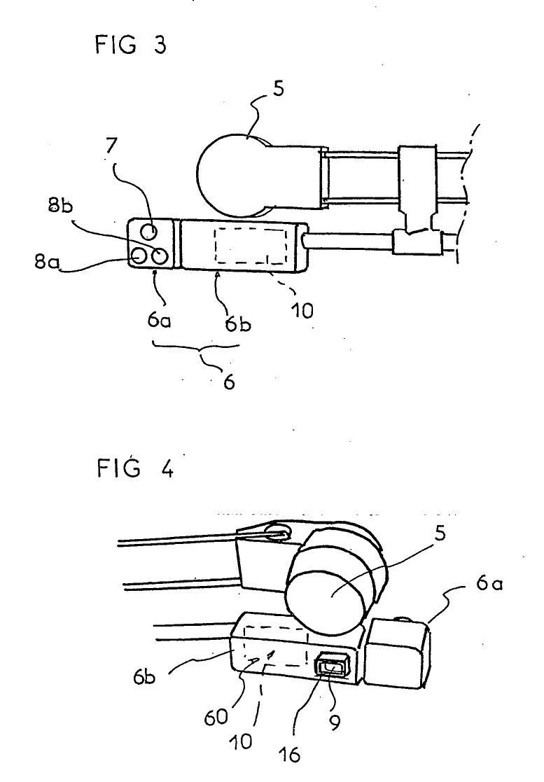

### DETAILED DESCRIPTION OF THE PREFERRED EMBODIMENT

According to the present example, the lighting system and its control device carrying the general reference 1 is carried at the end of a retaining arm 2 the other end of which is affixed to one of the lateral walls 3 of a protective helmet 4.

The arms 2 detach into two parts, the one of which carries at its free end the lighting system and its control device, is articulated on the other, affixed to the helmet, in a manner permitting its adjustment to the user and its return more conveniently to a resting place removal of the helmet.

Its retaining arms 2 affixed to the helmet 4 are known for carrying, for example, a microphone 5. Also the retaining arms sensibly extend horizontally to the lateral wall 3 of the helmet towards the front and towards a median plane (P) of general symmetry of the helmet, so that its free extremity, which carries the lighting device 1 and the microphone 5 are situated in proximity and before the mouth of the user.

Always according to the present invention, the ensemble 1 includes the lighting system which is contained in a case 6 advantageously placed below the microphone 5 and includes electroluminescent diodes 7, 8a, 8b like, for example, an electroluminescent infrared light diode 7 and one or two more electroluminescent visible light diodes 8a, 8b.

Preferably, the lighting system will itself also serve to light the exterior environment of the plane by the intermediary external light sources.

Under the circumstances, the casing 6 includes two parts: an end part, called the light casing 6a containing the electroluminescent diodes 7, 8a, 8b and another part, laterally projecting towards the vertical wall 3 of the helmet 4, called the control casing 6b containing the control means and notably a movement sensor 9 and an electronic circuit 10.

The aforementioned casing 6 is, as in the preceding view, fixed onto the arms 2 of the microphone 5 and advantageously placed under the aforementioned microphone 5.

It goes without saying that the electric circuit 10 can be placed in another case as previously described for example separate from the helmet.

As seen, according to the invention, the control device 6b of the lighting system 6a is activated entirely without hands and is activated only by the movement(s) of the mouth of the user.

To that effect, the back side 60 of the casing 6b includes an optical sensor or a capacitive sensor 9 designed to capture the movement(s) of the mouth. The aforementioned sensor 9 is carried by the control casing 6b which includes an electronic circuit 10 supplied by an electric current, for example, by a 3.6 volt power supply.

Thus, the sensor 9 can be, by the intermediary of the electric circuit 10 used as:
The control for the lighting or extinction of the visible light electroluminescent diodes
The control for the lighting or extinction of the infrared light electroluminescent diodes
The control for the intensity of the light.

Note that the casing or control module 6b advantageously includes a programmable controller 16.

A case 11 includes a general switch 12 designed to start and stop the device.

This case can be carried by the retaining arms 2 or placed on the back of the helmet like, for example, under the cover. It includes, in addition to the general switch 12, an electronic circuit 13 which may be powered by batteries or by rechargeable batteries 14, or connected to the general supply 15 which is usually disposed on his plane. To that effect, it is contemplated that an electric converter allows the passage from the 28 volts onboard power supply of 3.6 volts to insure the illumination of the lighting system.

FIG. 2 illustrates a schematic view of the system's electric circuit.

According to the preferred embodiment, the sensor 9 is placed in a well formed by a peripheral wall jutting towards the mouth of the user.

The control takes place by introducing the tongue between the teeth and lower lip, which creates an embossing of the lower lip which is detected by the motion sensor 9, placed an adequate distance from the mouth of the user, when the lower lip approaches the well of the control, the following functions occur:

If all the electroluminescent diodes are extinguished:
One rapid thrust of 0.2 to 0.4 seconds illuminates the lighting diodes
Two rapid thrusts illuminate the infrared diode

If the diodes are illuminated:
One rapid thrust extinguishes the lighted diodes
One longer thrust, for example, of 0.7 seconds, launches the stepping of an electronic dimmer.

Of course, the invention is not limited by the methods described and shown in the titles of the examples, but is inclusive of all other equivalent techniques and their combinations.

1. A control device for a lighting system of visible and infrared light designed to be fixed to a lateral wall of a helmet by a retaining arm including:
an optical sensor or a capacitive sensor which captures movement(s) of a mouth of a user independent of the user's hands.

2. The control device according to claim 1, wherein the sensor is disposed at the end of a retaining arm independent of the helmet in the articulated manner.

3. The control device according to claim 1, further including:
a lighting system mounted in a case.

4. The control device according to claim 3, wherein the case includes two parts, an end part defines a lighting case and another part including a control case which houses the sensor.

5. The control device according to claim 4, wherein the control case houses a reprogrammable microcontroller and an electronic circuit powered by an electric.

6. The control device claim 1, further including:
a supply case containing a general switch and an electronic circuit supplied by a source of electric current.

7. The control device according to claim 1, wherein the movement sensor uses an electric circuit to:
control the lighting or extinction of the visible light diodes
control the lighting or extinction of the infrared light diodes
control the intensity of the lighting.

8. The control device according to claim 1, wherein the control is made by introducing the tongue between the teeth and lower lip which creates an embossing of the lower lip which is detected by the movement sensor.

9. The control device according to claim 1, wherein the controlled function are as follows:
when all the diodes are extinguished:
a rapid thrust of 0.2 to 0.4 seconds illuminates the lighting diodes
two rapid thrusts illuminate the infrared diode
when the diodes are illuminated:
a rapid thrust extinguishes the lighted diodes
a longer thrust, launches the stepping of an electronic dimmer.

10. A control device for controlling a lighting system comprising:
a motion sensor mounted to a helmet and positioned to sense movement of a wearer's lower lip;
a control circuit for controlling an amount of power sent to at least one light for at least one of turning the light OFF, turning the light ON, and changing an intensity with which the light is illuminated.
